(19) United States
(12) Patent Application Publication
(10) Pub. No.: US 2016/0345125 A1
(43) Pub. Date: Nov. 24, 2016

(54) ELECTRONIC DEVICE AND METHOD FOR PERFORMING WIRELESS COMMUNICATION THEREOF

(71) Applicant: Samsung Electronics Co., Ltd., Suwon-si (KR)

(72) Inventors: Minsoo KIM, Gumi-si (KR); Heedong LEE, Gumi-si (KR); Jiwoo LEE, Gumi-si (KR); Heekon KIM, Daegu (KR)

(21) Appl. No.: 15/136,145

(22) Filed: Apr. 22, 2016

(30) Foreign Application Priority Data
May 21, 2015 (KR) 10-2015-0070843

(51) Int. Cl. H04W 4/00; G06Q 20/40; G06Q 20/32; H04B 5/00

(52) U.S. Cl. CPC H04W 4/008; H04B 5/0037; H04B 5/0081; G06Q 20/40145; G06Q 20/3278

(57) ABSTRACT

An electronic device is provided that includes a communication module including a first sub-communication module performing a short-range wireless communication function, a second sub-communication module performing a wireless charging function, and a third sub-communication module performing a security payment function, a coil module including a first coil used for performing the short-range wireless communication function and a second coil used for performing the wireless charging function, a switch module including one or more switches that electrically connect the communication module with the coil module, and a processor that identifies whether a signal for requesting activation of the third sub-communication module is received, and if the request signal is received, electrically connects the third sub-communication module, the first coil, and the second coil through the switch module, and performs the security payment function by using the first coil and the second coil, which are connected with the third sub-communication module.

### CROSS-REFERENCE TO RELATED APPLICATION(S)

This application claims the benefit under 35 U.S.C. §119(a) of a Korean patent application filed on May 21, 2015 in the Korean Intellectual Property Office and assigned Serial number 10-2015-0070843, the entire disclosure of which is hereby incorporated by reference.

### TECHNICAL FIELD

The present disclosure relates to a method of performing the wireless communication of an electronic device. More particularly, the present disclosure relates to an electronic device that performs a short-range communication function, a wireless charging function, or a security payment function by using a plurality of coil antennas, and a method of performing a wireless communication thereof.

### BACKGROUND

Coil antennas may have a closed-loop antenna form, and specifically, may have a single input terminal and a single output terminal. When applying a current to the input terminal of the coil antenna, an electromagnetic induction effect may occur in the coil antenna. The electromagnetic induction may be changed by the coil inductance. The coil inductance may be determined by the number of turns, the winding area, the winding direction, or the winding diameter of the coil. The coil antenna may transmit information in the form of a pulse signal through the electromagnetic inductance.

The coil antenna may be different in its structure from the radio frequency (RF) antenna that is used in Bluetooth (BT), global positioning system (GPS), wide-band code division multiple access (WCDMA), long-term evolution (LTE), or the like. The RF antenna is mainly suitable for high-frequency communication that ranges from several MHz to several GHz, and a planar inverted F antenna (PIFA) type of antenna may usually be used. A PIFA type of antenna requires an input terminal that is comprised of a ground portion and a power supply portion, and in some cases, a circuit may be configured with a single input terminal that is connected to the power supply portion, except for the ground portion that uses a common ground. On the contrary, the coil antenna requires one or more input terminals for controlling the current direction and an output terminal, and may be mainly used in low-frequency communication and magnetic field communication for a short communication distance.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method of performing the wireless communication of an electronic device that executes a communication function of the third communication module by using the first coil used for a communication function of the first communication module and the second coil used for a communication function of the second communication module.

In order to use a plurality of communication modules, dedicated coil antennas, which are connected with each communication module, are required. It is difficult to secure a mounting space for a plurality of coil antennas in current electronic devices, and the addition of the coil antennas may lead to additional costs.

In accordance with an aspect of the present disclosure, an electronic device is provided. The electronic device includes a communication module that includes a first sub-communication module configured to perform a short-range wireless communication function, a second sub-communication module configured to perform a wireless charging function, and a third sub-communication module configured to perform a security payment function, a coil module that includes a first coil used for performing the short-range wireless communication function and a second coil used for performing the wireless charging function, a switch module that includes one or more switches that electrically connect the communication module with the coil module based on a control signal for controlling a connection between the communication module and the coil module, and a processor configured to control to identify whether or not a signal for requesting activation of the third sub-communication module is received, and in response to the request signal being received, electrically connects the third sub-communication module, the first coil, and the second coil through the switch module, and perform the security payment function by using the first coil and the second coil, which are connected with the third sub-communication module.

In accordance with another aspect of the present disclosure, a method for performing wireless communication in an electronic device is provided. The method includes a communication module that includes a first sub-communication module configured to perform a short-range wireless communication function, a second sub-communication module configured to perform a wireless charging function, and a third sub-communication module configured to perform a security payment function may include identifying whether or not a signal for requesting activation of the third sub-communication module is received, in response to the request signal being received, electrically connecting the third sub-communication module, the first coil, and the second coil through a switch module, and performing the security payment function by using the first coil and the second coil, which are connected with the third sub-communication module.

The method of performing wireless communication of an electronic device, according to various embodiments of the present disclosure, can perform a communication function of the third communication module by using the first coil used for a communication function of the first communication module and the second coil used for a communication function of the second communication module without an additional coil dedicated to the third communication module.

The method of performing wireless communication of an electronic device, according to various embodiments of the present disclosure, can control a connection between a variable terminal in the coil and a switch module based on at least one of the proximity between the electronic device and an external device or the positioning state of the electronic device with respect to the external device in order to thereby extend the communication range of the communication module.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device according to various embodiments of the present disclosure;

FIG. 2 is a flowchart showing the operation of performing a security payment function of the third sub-communication module by the electronic device according to various embodiments of the present disclosure;

FIG. 3A illustrates the operation in which the first sub-communication module of the electronic device performs a short-range wireless communication function by using the first coil and the second sub-communication module performs a wireless charging function by using the second coil, according to various embodiments of the present disclosure;

FIG. 3B to FIG. 3D illustrate the operation in which the third sub-communication module of the electronic device performs a security payment function by using the first coil and the second coil, which are arranged in a subordinate structure, according to various embodiments of the present disclosure;

FIG. 4 is a flowchart showing the operation in which the electronic device identifies whether or not a signal for requesting the activation of the third sub-communication module is received, according to various embodiments of the present disclosure;

FIGS. 5A and 5B illustrate the operation in which the electronic device adjusts the inductance of a coil module in order to extend the communication range of the communication module, according to various embodiments of the present disclosure; and

FIGS. 6A and 6B illustrate a coil module in which two or more coils are arranged in parallel according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An expression “comprising”, “may comprise”, “comprises”, “comprising” used in the present disclosure indicates presence of a corresponding function, operation, element, presence of a characteristic, numeral, operation, element, component, or combination thereof described in a specification and does not limit additional at least one function, operation, element presence of a characteristic, numeral, operation, element, component, or combination thereof described in a specification. In the present disclosure, an expression “or” includes any combination or the entire combination of together listed words. An expression of a first and a second in the present disclosure may represent various elements of the present disclosure, but does not limit corresponding elements. For example, the expression does not limit order and/or importance of corresponding elements. The expression may be used for distinguishing one element from another element. For example, both a first user device and a second user device are user devices and represent different user devices. For example, a first constituent element may be referred to as a second constituent element without deviating from the scope of the present disclosure, and similarly, a second constituent element may be referred to as a first constituent element.

When it is described that an element is “coupled” to another element, the element may be “directly coupled” electrically or physically to the other element, or “electrically coupled” to the other element through a third element. However, when it is described that an element is “directly coupled” to another element, no element may exist between the element and the other element.

Terms used in the present disclosure are not to limit the present disclosure but to illustrate various embodiments.

Unless differently defined, entire terms including a technical term and a scientific term used here have the same meaning as a meaning that may be generally understood by a person of common skill in the art. It should be analyzed that generally using terms defined in a dictionary have a meaning corresponding to that of a context of related technology and are not analyzed as an ideal or excessively formal meaning unless explicitly defined.

In this disclosure, an electronic device may be a device that involves a communication function. For example, an electronic device may be a smart phone, a tablet personal computer (PC), a mobile phone, a video phone, an e-book reader, a desktop PC, a laptop PC, a netbook computer, a personal digital assistant (PDA), a portable multimedia player (PMP), a moving picture experts group phase 1 or phase 2 (MPEG-1 or MPEG-2) audio layer 3 (MP3) player, a portable medical device, a digital camera, or a wearable device (e.g., a head-mounted device (HMD) such as electronic glasses, electronic clothes, an electronic bracelet, an electronic necklace, an electronic appcessory, or a smart watch), just to name a few non-limiting possibilities.

According to some embodiments, an electronic device may be a smart home appliance that involves a communication function. For example, an electronic device may be a television (TV), a digital video disc (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame, just to name a few non-limiting possibilities.

According to some embodiments, an electronic device may be a medical device (e.g., magnetic resonance angiography (MRA), magnetic resonance imaging (MRI), computed tomography (CT), ultrasonography, etc.), a navigation device, a global positioning system (GPS) receiver, an event data recorder (EDR), a flight data recorder (FDR), a car infotainment device, electronic equipment for ship (e.g., a marine navigation system, a gyrocompass, etc.), avionics, security equipment, or an industrial or home robot, just to name a few non-limiting possibilities.

According to some embodiments, an electronic device may be furniture, or part of a building, or a construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. As well understood by those skilled in the art, the above-mentioned electronic devices are not to be considered as a limitation of this disclosure, just to name a few non-limiting possibilities.

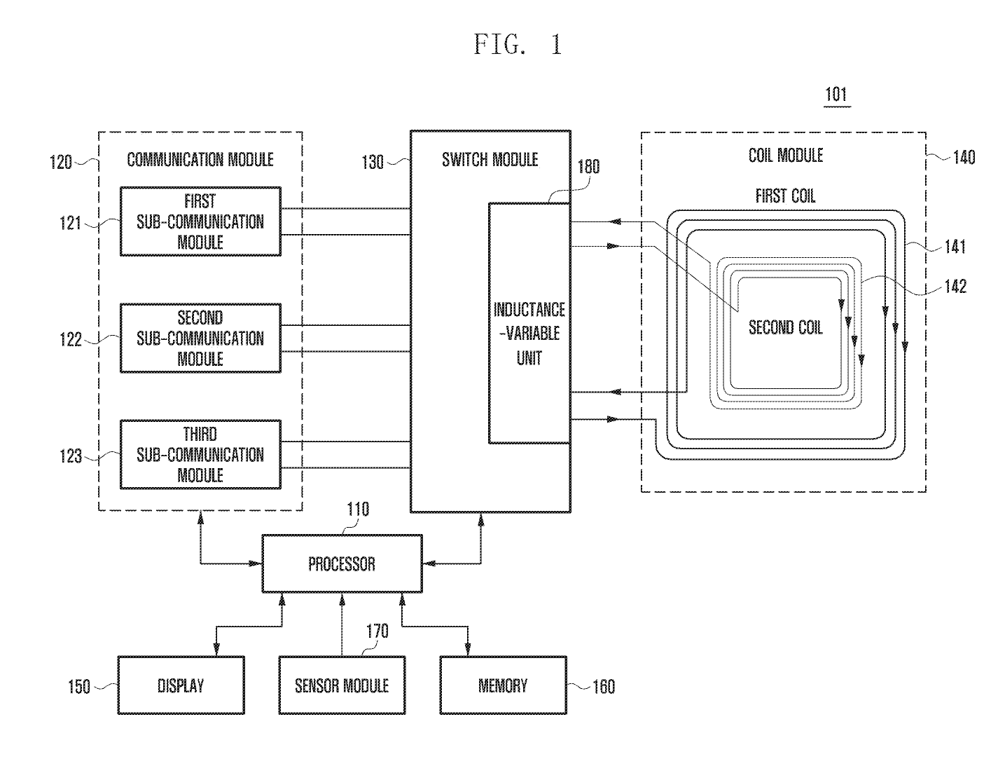

FIG. 1 is a block diagram of the electronic device 101 according to various embodiments of the present disclosure.

The electronic device 101 may include one or more processors 110, a communication module 120, a switch module 130, a coil module 140, a display 150, a memory 160, a sensor module 170, or a camera module (not shown).

The processor 110, for example, may control a multitude of hardware or software elements, which are connected with the processor 110, and may perform the processing of various pieces of data and a calculation by executing an operating system or application programs. The processor 110 may be implemented by, for example, a system on chip (SoC). According to an embodiment, the processor 110 may further include a graphics processing unit (GPU) and/or an image signal processor (ISP). The processor 110 may include at least some of the elements (e.g., the switch module) shown in FIG. 1. The processor 110 may load instructions or data received from one or more other elements (e.g., a non-volatile memory) to a volatile memory to then be processed, and may store various pieces of data in a non-volatile memory.

The communication module 120 may perform the transmission and reception of data between the electronic device 101 and other electronic devices that are connected with the electronic device 101 through networks. The communication module 120 may include the first sub-communication module 121, the second sub-communication module 122, and the third sub-communication module 123. The first sub-communication module 121 may perform a short-range wireless communication function, and may include a communication module that uses the coil antennas, such a near field communication (NFC) module, a Wi-Fi module, or the like. The second sub-communication module 122 may perform a wireless charging function, and may include at least one of a wireless power consortium (WPC) module or a power matters alliance (PMA) module. The third sub-communication module 123 may perform a security payment function, and may include a magnetic secure transmission (MST) module.

The switch module 130 may electrically connect the communication module 120 with the coil module 140 under the control of the processor 110 by using one or more switches that are included in the switch module 130. The switch module 130 may include an inductance-variable unit 180. The inductance-variable unit 180 may adjust the inductance of the coil module 140 by using one or more variable terminals that are included in the coil module 140.

The switch module 130, according to various embodiments of the present disclosure, may include the first switch 131, the second switch 132, the third switch 133, and the fourth switch 134.

According to an embodiment, the first switch 131 may operate to electrically connect the input terminal 141a of the first coil 141 to the output terminal 121a of the first sub-communication module 121 or to the output terminal 123a of the third sub-communication module 123. The second switch 132 may operate to electrically connect the output terminal 141b of the first coil 141 to the input terminal 121b of the first sub-communication module 121 or to the input terminal 142a of the second coil 142. The third switch 133 may operate to electrically connect the input terminal 142a of the second coil 142 to the output terminal 122a of the second sub-communication module 122 or to the output terminal 141b of the first coil 141. The fourth switch 134 may operate to electrically connect the output terminal 142b of the second coil 142 to the input terminal 122b of the second sub-communication module 122 or to the input terminal 123b of the third sub-communication module 123.

According to another embodiment, the first switch 131 may operate to electrically connect the input terminal 142a of the second coil 142 to the output terminal 122a of the second sub-communication module 122 or to the output terminal 123a of the third sub-communication module 123. The second switch 132 may operate to electrically connect the output terminal 142b of the second coil 142 to the input terminal 122b of the second sub-communication module 122 or to the input terminal 141a of the first coil 141. The third switch 133 may operate to electrically connect the input terminal 141a of the first coil 141 to the output terminal 121a of the first sub-communication module 121 or to the output terminal 142b of the second coil 142. The fourth switch 134 may operate to electrically connect the output terminal 141b of the first coil 141 to the input terminal 121b of the first sub-communication module 121 or to the input terminal 123b of the third sub-communication module 123.

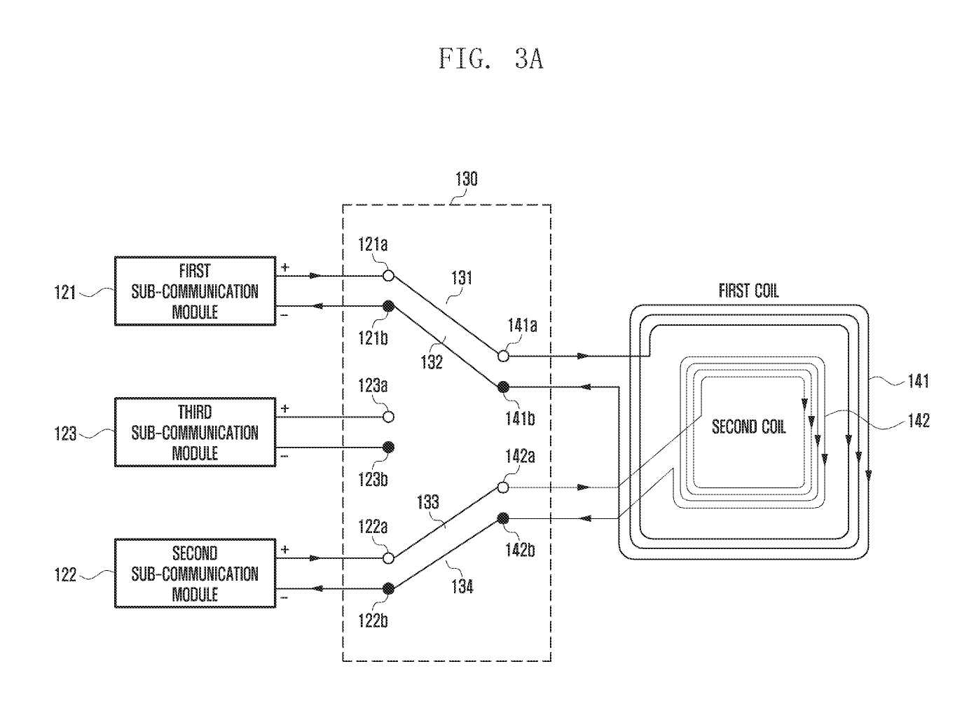

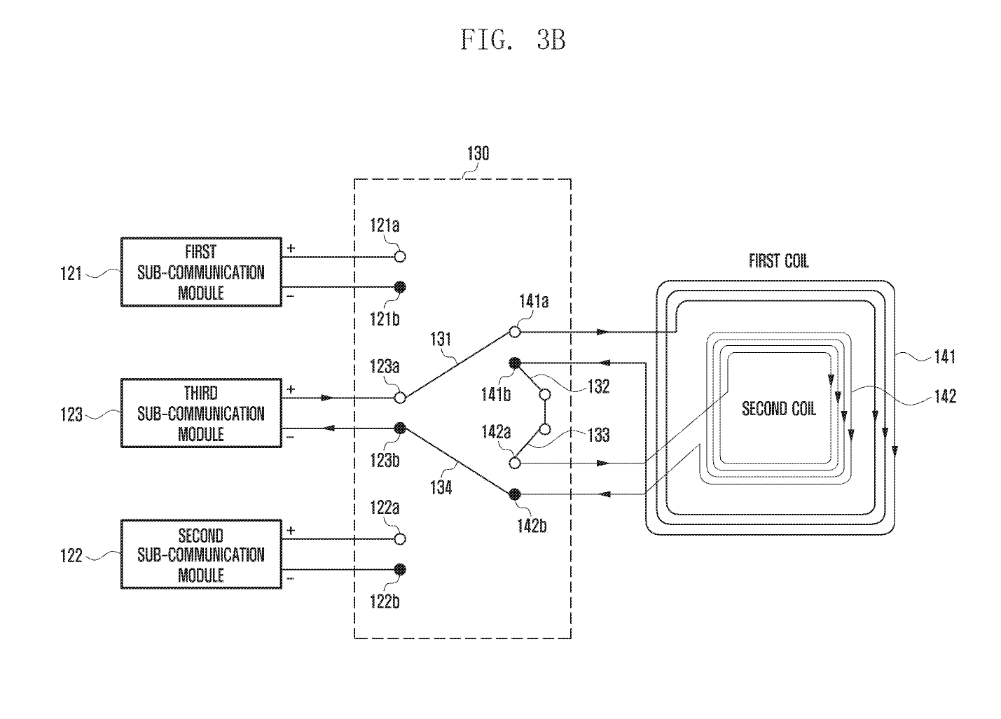

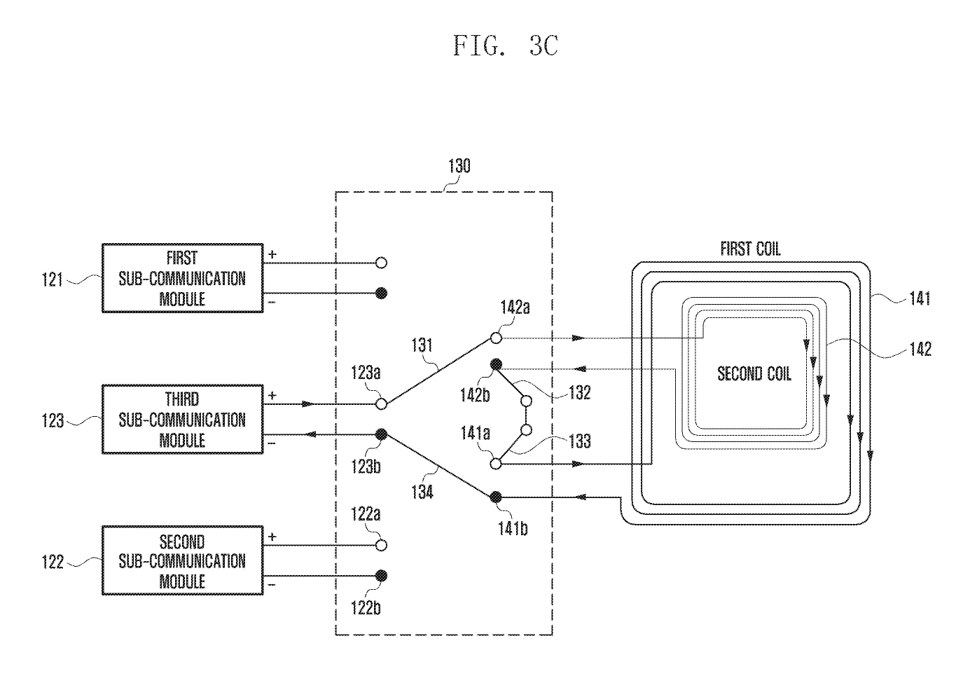

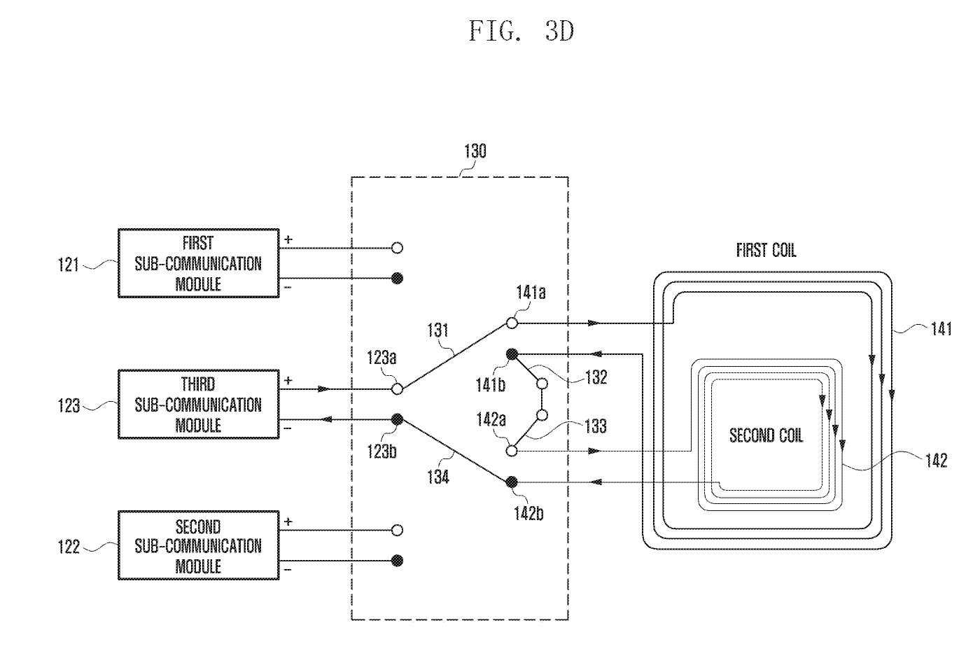

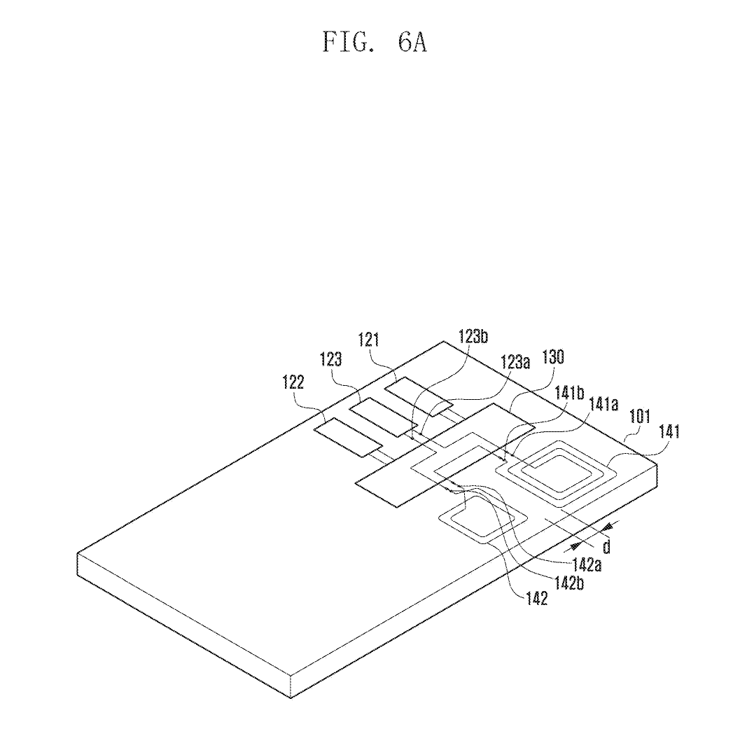

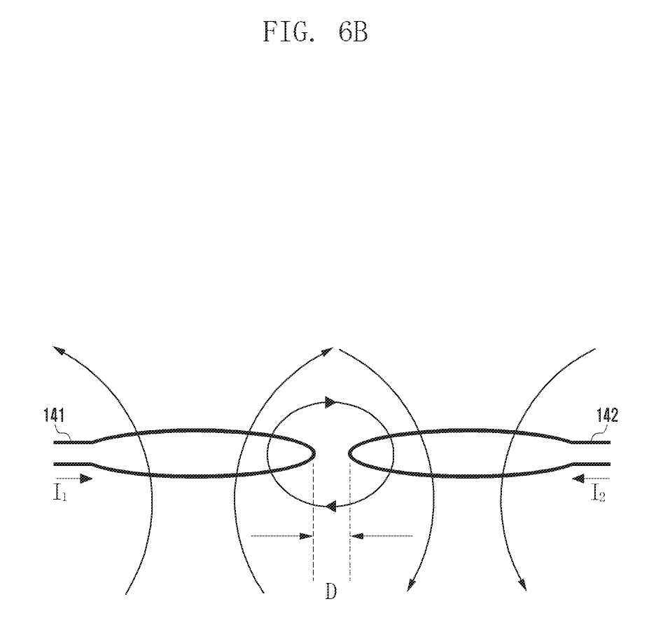

The coil module 140 may be utilized to perform a communication function of the communication module 120. The coil module 140 may include the first coil 141 and the second coil 142. The first sub-communication module 121 may perform a short-range wireless communication function through the first coil 141. The second sub-communication module 122 may perform a wireless charging function through the second coil 142. The third sub-communication module 123 may perform a security payment function through the first coil 141 and the second coil 142. The first coil 141 and the second coil 142 may include one or more variable terminals. The first coil 141 and the second coil 142, which are contained in the coil module 140, may be arranged in a subordinate structure or in a parallel structure. The subordinate structure will be described with reference to FIG. 3A to FIG. 3D, and the parallel structure will be described with reference to FIGS. 6A and 6B.

The display 150 may include a panel, a hologram, or a projector. The panel may be, for example, a liquid crystal display (LCD), active matrix organic light emitting diode (AM-OLED), or the like, just to name some non-limiting possibilities. The panel may have a flexible, transparent or wearable form. The panel may be formed of a single module with the touch panel. The hologram may show a stereoscopic image in the air using interference of light. The projector may project an image onto a screen, which may be located at the inside or outside of the electronic device 101. According to an embodiment, the display 150 may further include a control circuit for controlling the panel, the hologram, and the projector.

The memory 160 may include an internal memory and an external memory. The internal memory may include, for example, at least one of a volatile memory (e.g., dynamic random access memory (DRAM), static RAM (SRAM), synchronous DRAM (SDRAM), etc.) or a nonvolatile memory (e.g., one time programmable read only memory (OTPROM), programmable ROM (PROM), erasable and programmable ROM (EPROM), electrically erasable and programmable ROM (EEPROM), mask ROM, flash ROM, NAND flash memory, NOR flash memory, etc.), just to name some non-limiting possibilities.

According to an embodiment, the internal memory may have the form of a solid state drive (SSD). The external memory may include a flash drive, e.g., compact flash (CF), secure digital (SD), micro SD, mini SD, eXtreme digital (xD), memory stick, or the like. The external memory may be functionally connected to the electronic device 101 through various interfaces. According to an embodiment, the electronic device 101 may further include a storage device or medium such as a hard drive.

The sensor module 170, which is comprised of hardware, may measure a physical quantity or sense an operating status of the electronic device 101, and then convert measured or sensed information into electric signals. The sensor module 170 may include, for example, at least one of a gesture sensor, a gyro sensor, an atmospheric sensor, a magnetic sensor, an acceleration sensor, a grip sensor, a proximity sensor, a color sensor (e.g., red, green, blue (RGB) sensor), a biometric sensor, a temperature-humidity sensor, an illumination sensor, and a ultraviolet (UV) sensor. Additionally or alternatively, the sensor module 170 may include, e.g., an E-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris scan sensor (not shown), or a finger scan sensor (not shown). Also, the sensor module 170 may include a control circuit for controlling one or more sensors equipped therein.

The camera module (not shown) may photograph still images and moving images, and may include one or more image sensors (e.g., a front sensor or a rear sensor), lenses (not shown), an ISP (not shown), or a flash (e.g., LED or xenon lamp) (not shown).

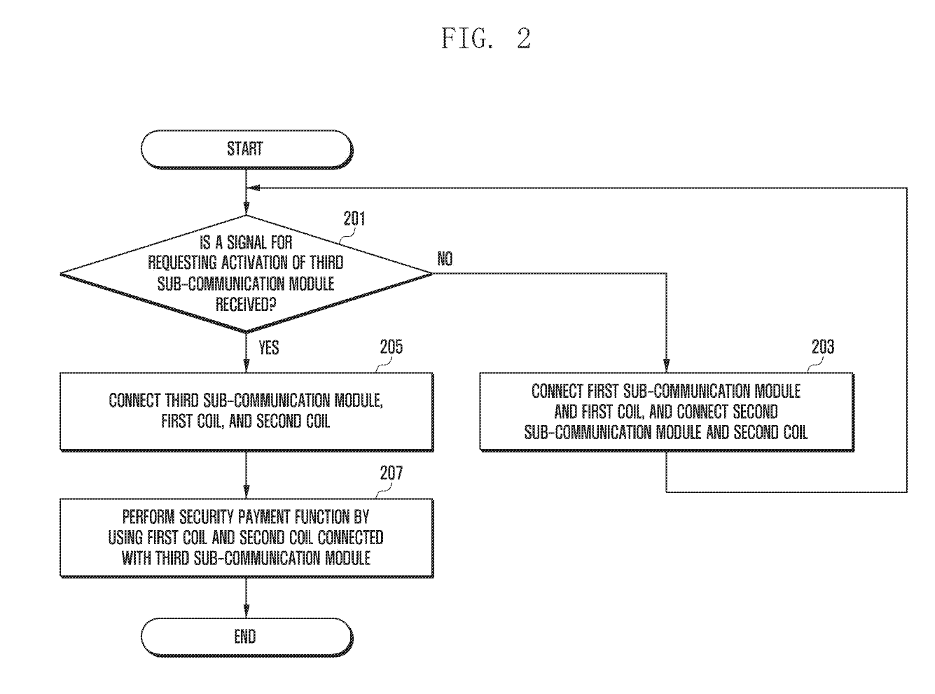

FIG. 2 is a flowchart showing the operation in which the electronic device 101 performs a security payment function of the third sub-communication module 123 according to various embodiments of the present disclosure.

The electronic device 101 may identify whether or not a signal for requesting the activation of the third sub-communication module 123 is received in operating 201. The signal for requesting the activation of the third sub-communication module 123 may be created by a user input. For example, when the user executes an MST payment application in order to perform the security payment function of the third sub-communication module 123, the electronic device 101 may determine that the signal for requesting the activation of the third sub-communication module 123 has been received.

If the signal for requesting the activation of the third sub-communication module 123 is not received, the electronic device 101 may electrically connect the first sub-communication module 121 with the first coil 141 and may electrically connect the second sub-communication module 122 and the second coil 142 in operation 203.

The electronic device 101, according to various embodiments of the present disclosure, may electrically connect the first sub-communication module 121 and the first coil 141 by using the switch module 130.

FIG. 3A illustrates the operation in which the first sub-communication module of the electronic device performs a short-range wireless communication function by using the first coil and the second sub-communication module performs a wireless charging function by using the second coil, according to various embodiments of the present disclosure.

For example, referring to FIG. 3A, the electronic device 101 may operate the first switch 131 such that the output terminal 121a of the first sub-communication module 121 is connected with the input terminal 141a of the first coil 141. In addition, the electronic device 101 may operate the second switch 132 such that the input terminal 121b of the first sub-communication module 121 is connected with the output terminal 141b of the first coil 141. As a result, a current may flow from the output terminal 121a of the first sub-communication module 121 to the input terminal 141a of the first coil 141, and may flow from the output terminal 141b of the first coil 141 to the input terminal 121b of the first sub-communication module 121. The first sub-communication module 121 may perform a short-range wireless communication function by using the electromagnetic induction that occurs due to the current flowing through the first coil 141. The short-range wireless communication function, for example, may include an NFC function.

The electronic device 101, according to various embodiments of the present disclosure, may electrically connect the second sub-communication module 122 and the second coil 142 by using the switch module 130. For example, referring to FIG. 3A, the electronic device 101 may operate the third switch 133 such that the output terminal 122a of the second sub-communication module 122 is connected with the input terminal 142a of the second coil 142. In addition, the electronic device 101 may operate the fourth switch 134 such that the input terminal 122b of the second sub-communication module 122 is connected with the output terminal 142b of the second coil 142. Consequently, a current that is generated in the second coil 142 by the electromagnetic induction is output from the output terminal 142a of the second coil 142 to then be input into the input terminal 122b of the second sub-communication 122. The second sub-communication module 122 may perform a wireless charging function by using the current generated in the second coil 142 by the electromagnetic induction. The wireless charging function may include at least one of a WPC type of wireless charging function or a PMA type of wireless charging function.

If a signal for requesting the activation of the third sub-communication module 123 is received, the electronic device 101 may electrically connect the third sub-communication module 123, the first coil 141, and the second coil 142 by using the switch module 130 in operation 205.

The electronic device 101, according to various embodiments of the present disclosure, may electrically connect the third sub-communication module 123, the first coil 141, and the second coil 142 such that the current flows: from the third sub-communication module 123 to the first coil 141; from the first coil 141 to the second coil 142; and from the second coil 142 to the third sub-communication module 123. The electronic device 101 may control the switch module 130 such that the direction of the magnetic field generated in the first coil 141 is the same as the direction of the magnetic field generated in the second coil 142 in order to electrically connect the third sub-communication module 123, the first coil 141, and the second coil 142.

FIG. 3B to FIG. 3D illustrate the operation in which the third sub-communication module of the electronic device performs a security payment function by using the first coil and the second coil, which are arranged in a subordinate structure, according to various embodiments of the present disclosure.

For example, referring to FIG. 3B, the electronic device 101 may operate the first switch 131 such that the output terminal 123a of the third sub-communication module 123 is connected with the input terminal 141a of the first coil 141. The electronic device 101 may operate the second switch 132 and the third switch 133 such that the output terminal 141b of the first coil 141 is connected with the input terminal 142a of the second coil 142. The electronic device 101 may operate the fourth switch 134 such that the output terminal 142b of the second coil 142 is connected with the input terminal 123b of the third sub-communication module 123. As a result, the current flows: from the output terminal 123a of the third sub-communication module 123 to the input terminal 141a of the first coil 141; from the output terminal 141b of the first coil 141 to the input terminal 142a of the second coil 142; and then from the output terminal 142b of the second coil 142 to the input terminal 123b of the third sub-communication module 123. The current flows through the first coil 141 and the second coil 142 in the same direction, and as a result thereof, the direction of the electromagnetic induction may be the same. The third sub-communication module 123 may perform the security payment function by using the electromagnetic induction that occurs due to the current through the first coil 141 and the second coil 142. The security payment function, for example, may include an MST function. The electronic device 101 is not limited to the embodiment above, and may control the switch module 130 such that the direction of the electromagnetic induction of the first coil 141 is the same as the direction of the electromagnetic induction of the second coil 142 regardless of the winding direction of the coil.

The electronic device 101, according to various embodiments of the present disclosure, may electrically connect the third sub-communication module 123, the first coil 141, and the second coil 142 such that the current flows: from the third sub-communication module 123 to the second coil 142; from the second coil 142 to the first coil 141; and then from the first coil 141 to the third sub-communication module 123.

For example, referring to FIG. 3C, the electronic device 101 may operate the first switch 131 such that the output terminal 123a of the third sub-communication module 123 is connected with the input terminal 142a of the second coil 142. The electronic device 101 may operate the second switch 132 and the third switch 133 such that the output terminal 142b of the second coil 142 is connected with the input terminal 141a of the first coil 141. The electronic device 101 may operate the fourth switch 134 such that the output terminal 141b of the first coil 141 is connected with the input terminal 123b of the third sub-communication module 123. As a result, the current flows: from the output terminal 123a of the third sub-communication module 123 to the input terminal 142a of the second coil 142; from the output terminal 142b of the second coil 142 to the input terminal 141a of the first coil 141; and from the output terminal 141b of the first coil 141 to the input terminal 123b of the third sub-communication module 123.

The electronic device 101, according to various embodiments of the present disclosure, may electrically connect the third sub-communication module 123, the first coil 141, and the second coil 142 such that the direction of the electromagnetic induction of the first coil 141 is the same as that of the second coil 142 based on the winding direction of the coil. Since the third sub-communication module 123 uses the first coil 141 and the second coil 142 as a single coil by electrically connecting the same, the electromagnetic-induced directions, which are generated in the first coil 141 and the second coil 142, are required to be the same. In the case where the first coil 141 is wound clockwise and the second coil 142 is wound clockwise as shown in FIG. 3B, since the winding directions of the coils are the same, the switch module 130 may be operated as the embodiment of FIG. 3B. In the case where the first coil 141 is wound clockwise and the second coil 142 is wound counterclockwise as shown in FIG. 3B, since the winding directions of the coils are different from each other, the switch module 130 may be operated such that the direction of the electromagnetic induction generated in the first coil 141 is the same as the direction of the electromagnetic induction generated in the second coil 142.

For example, referring to FIG. 3D, the electronic device 101 may control the first switch 131 such that the output terminal 123a of the third sub-communication module 123 is connected with the input terminal 141a of the first coil 141. The electronic device 101 may control the second switch 132 and the third switch 133 such that the output terminal 141b of the first coil 141 is connected with the input terminal 142a of the second coil 142. The electronic device 101 may control the fourth switch 134 such that output terminal 142b of the second coil 142 is connected with the input terminal 123b of the third sub-communication module 123. As a result, the current flows: from output terminal 123a of the third sub-communication module 123 to input terminal 141a of the first coil 141; from the output terminal 141b of the first coil 141 to the input terminal 142a of the second coil 142; and then from the output terminal 142b of the second coil 142 to the input terminal 123b of the third sub-communication module 123. In this case, although the winding direction of the first coil 141 is opposite to the winding direction of the second coil 142, since the current flows in the same direction, i.e., in the clockwise direction, the direction of the electromagnetic induction of the first coil 141 is the same as that of the second coil 142. The electronic device 101, according to various embodiments of the present disclosure, is not limited to the embodiment above, and the switch module 130 may be operated such that the direction of the electromagnetic induction of the first coil 141 matches the direction of the electromagnetic induction of the second coil 142.

In operation 207, the electronic device 101 may perform the security payment function by using the first coil 141 and the second coil 142, which are connected with the third sub-communication module 123. The security payment function may include a MST function. The electronic device 101 may transmit payment information that requests payment to the external device (point of sales (POS)) by using the security payment function.

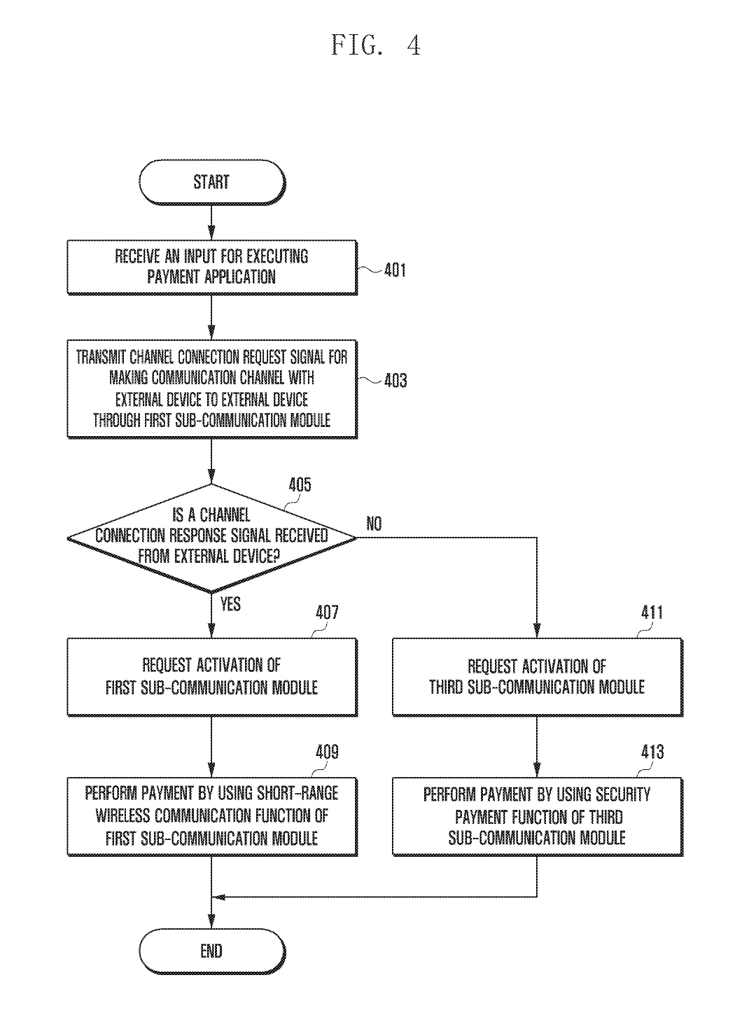

FIG. 4 is a flowchart showing the operation in which the electronic device 101 identifies whether or not a signal for requesting the activation of the third sub-communication module 123 is received, according to various embodiments of the present disclosure.

The electronic device 101 may receive an input for executing a payment application in operation 401. The electronic device 101 may perform an authentication request to identify the user, such as a fingerprint authentication request or an ˜˜(ARS) authentication request, in order to execute the payment application. The payment applications may perform a payment function through one of the first sub-communication module 121 that performs a short-range wireless communication function or the third sub-communication module 123 that performs a security payment function. The short-range wireless communication function may include an NFC payment function, and the security payment function may include an MST payment function.

The electronic device 101 may transmit a channel connection request signal for making a communication channel with the external device (POS) to the external device through the first sub-communication module 121 in operation 403.

The electronic device 101 may determine whether or not a channel connection response signal is received from the external device through the first sub-communication module 121 in response to the channel connection request signal in operation 405. For example, since the first sub-communication module 121 for a short-range wireless communication function performs two-way communication (Tx and Rx), and the third sub-communication module 123 for a security payment function performs only one-way communication (Tx), a communication module to communicate with the external device may be determined based on the reception of the channel connection response signal (Rx) in response to the channel connection request signal (Tx).

If the electronic device 101 receives the channel connection response signal from the external device, the electronic device 101 may request the activation of the first sub-communication module 121 in operation 407.

The electronic device 101 may make a payment by using the short-range wireless communication function of the first sub-communication module 121 in operation 409. More specifically, the electronic device 101 may convert payment information that contains user information or card information into information that conforms to the communication standard of the first sub-communication module 121 to then transmit the same to the external device through the first sub-communication module 121. The electronic device 101 may perform the NFC payment through the short-range wireless communication function of the first sub-communication module 121.

If the electronic device 101 fails to receive the channel connection response signal from the external device, the electronic device 101 may request the activation of the third sub-communication module 123 in operation 411.

The electronic device 101 may make a payment by using the security payment function of the third sub-communication module 123 in operation 413. More specifically, in order to make a request to the external device for payment, the electronic device 101 may convert payment information that contains user information or card information into information that conforms to the communication standard of the third sub-communication module 123, and may transmit the payment information to the external device through the first coil 141 and the second coil 142, which are connected with the third sub-communication module 123.

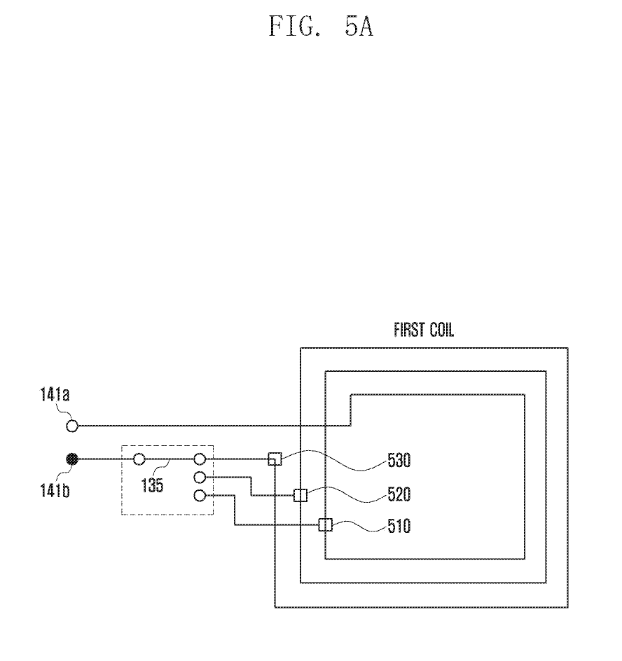

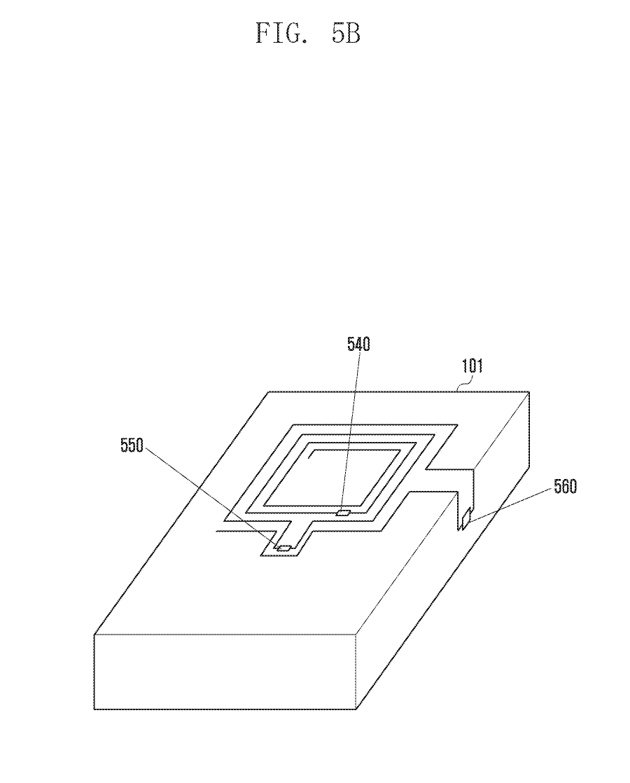

FIGS. 5A and 5B illustrate the operation in which the electronic device 101 adjusts the inductance of the coil module 140 in order to extend the communication range of the communication module 120, according to various embodiments of the present disclosure.

The electronic device 101 may adjust the inductance of at least one of the first coil 141 or the second coil 142 based on the proximity between the external device (POS) and the electronic device 101. The electronic device 101 may use a sensor module 170 that includes an infrared proximity sensor including a heart rate sensor, a capacitive proximity sensor, or an image sensor in order to determine the proximity with respect to the external device. For example, the electronic device 101 may determine the proximity with respect to the external device by using infrared rays from the heart rate sensor. In addition, the electronic device 101 may determine the proximity according to a change in the capacitance between the external device and the electronic device 101 by using the capacitive proximity sensor. In addition, the electronic device 101 may determine the proximity between the external device and the electronic device 101 by using a focal length of the external device, which is photographed by the image sensor of the camera module. The method for determining the proximity between the electronic device 101 and the external device is not limited to the embodiment above, and the proximity may be determined by using a variety of sensor modules. As the distance between the electronic device 101 and the external device increases, the proximity decreases. Therefore, the electronic device 101 may increase the inductance of the coil module 140 in order to thereby extend the communication distance and communication range of the communication module 120.

The electronic device 101, according to various embodiments of the present disclosure, may adjust the inductance of the coil module 140 by using the inductance-variable unit 180. At least one of the first coil 141 or the second coil 142, which are included in the coil module 140, may be connected to the inductance-variable unit 180 that is included in the switch module 130. The inductance-variable unit 180 may include a switch. The electronic device 101 may adjust the inductance of the coil through the switch. The coil module 140 may include one or more variable-terminals. For example, referring to FIG. 5A, the first coil 141 may include the first variable terminal 510, the second variable terminal 520, and the third variable terminal 530. The inductance-variable unit 180 may electrically connect one of the first variable terminal 510, the second variable terminal 520, or the third variable terminal 530 to the output terminal 141b of the first coil 141 by using the switch 135. The inductance of the coil module 140 may increase or decrease depending on the length between the input terminal of the coil and the variable terminal. For example, when the length between the input terminal 141a of the first coil 141 and the first variable terminal 510 is 11 mm, the inductance of the first coil 141 may be 15 uH, and when the length between the input terminal 141a of the first coil 141 and the second variable terminal 520 is 16 mm, the inductance of the first coil 141 may be 25 uH. In addition, when the length between the input terminal 141a of the first coil 141 and the third variable terminal 530 is 21 mm, the inductance of the first coil 141 may be 33 uH.

The electronic device 101, according to various embodiments of the present disclosure, may connect the variable terminal in the coil module 140 to the switch module 130 based on at least one of the proximity between the electronic device 101 and the external device or the position state of the electronic device with respect to the external device. According to an embodiment, the electronic device 101 may connect the variable terminal to the switch module 130 based on the proximity between the electronic device 101 and the external device. For example, referring to FIG. 5A, if it is determined that the proximity between the electronic device 101 and the external device is equal to, or more than, a predetermined value, the electronic device 101 may control the switch module 130 such that the first variable terminal 510 is connected to the switch 135. If it is determined that the proximity between the electronic device 101 and the external device is less than a predetermined value, the electronic device 101 may control the switch module 130 such that the second variable terminal 520 or the third variable terminal 530 is connected to the switch 135 in order to extend the communication range of the communication module 120. The operation of the electronic device 101, according to various embodiments of the present disclosure, is not limited to the embodiment above, and the electronic device 101 may control the switch module 130 such that a switch, which is connected with the input terminal of the first coil 141 or the second coil 142 included in the coil module 140, is connected to one or more variable terminals such that a switch, which is connected with the output terminal of the first coil 141 or the second coil 142, is connected to one or more variable terminals.

The electronic device 101, according to various embodiments of the present disclosure, may connect the variable terminal in the coil module 140 to the switch module based on the position state of the electronic device 101 with respect to the external device. When the electronic device 101 slants, in part, with respect to the external device, the electronic device 101 may connect a variable terminal, which is provided on the side of the electronic device 101 or protrudes from the side thereof, to the switch module. For example, referring to FIG. 5B, if the user allows the front side of the electronic device 101 to approach the external device, the electronic device 101 may control the switch module such that the fourth variable terminal 540 that is disposed in the center of the electronic device 101 is connected to the switch. If the user allows the lower end of the electronic device 101 to approach the external device, the electronic device 101 may control the switch module such that the fifth variable terminal 550 that is formed to protrude is connected to the switch. If the user allows the side of the electronic device 101 to approach the external device, the electronic device 101 may control the switch module such that the sixth variable terminal 560 that is provided on the side of the electronic device is connected to the switch. This is intended to extend the communication range of the communication module 120 on the basis of the position state of the electronic device 101 with respect to the external device.

FIGS. 6A and 6B illustrate the coil module 140 in which two or more coils are arranged in parallel according to various embodiments of the present disclosure.

The coil module 140, according to various embodiments of the present disclosure, may be arranged in a parallel structure in the electronic device 101 as shown in FIG. 6A, as well as in the subordinate structure as shown in FIG. 3A to FIG. 3D. If the distance between two or more coils included in the coil module 140 is within a predetermined value, the electronic device 101 may control the switch module 130 such that the directions of the electromagnetic induction generated in the coil module 140 are opposite to each other in order to thereby control the connection between the coil module 140 and the communication module 120. For example, referring to FIG. 6A, the first coil 141 and the second coil 142 may be arranged in parallel. It is assumed that the first coil 141 is wound clockwise, and the second coil 142 is wound counterclockwise. If the distance between the first coil 141 and the second coil 142 is equal to, or less than, a predetermined distance “d,” the electronic device 101 may control the connection between the communication module 120, the first coil 141 and the second coil 142 such that the direction of the electromagnetic induction generated in the first coil 141 is opposite to the direction of the electromagnetic induction generated in the second coil 142 by using the switch module 130. More specifically, the electronic device 101 may control the switch module 130 such that the output terminal 123a of the third sub-communication module of 123 and the input terminal 141a of the first coil 141 are connected with each other. The electronic device 101 may control the switch module 130 such that the output terminal 141b of the first coil 141 and the input terminal 142a of the second coil 142 are connected with each other. In this case, the current flows clockwise in the first coil 141. The electronic device 101 may control the switch module 130 such that the input terminal 142a of the second coil 142 and the input terminal 123b of the third sub-communication module 123 are connected with each other. In this case, the current flows counterclockwise in the second coil 142. Consequently, if the distance between the first coil 141 and the second coil 142 is less the predetermined distance “d,” the current flows in the opposite direction in the first coil 141 and the second coil 142, respectively, and the electromagnetic induction occurs in the opposite direction in the first coil 141 and the second coil 142 as well. In this case, referring to FIG. 6B, since the direction of the magnetic field formed in the first coil 141 is opposite to the direction of the magnetic field formed in the second coil 142 according to Ampere's law, the magnetic field that is cancelled between the two coils may be minimized, and thus the communications range of the third sub-communication module 123 may be extended.

Meanwhile, the above-described electronic device 101 may further include: a short-range communication module for short-range communication; an interface for transmitting and receiving data by a wired communication scheme or a wireless communication scheme of the electronic device 101; an Internet communication module that is connected with the Internet in order to thereby perform an Internet function; or a digital broadcasting module that performs a digital broadcast reception and reproduction function, which is not described above. These elements may be variously modified according to the convergence trend of digital devices, and cannot be all enumerated. However, the electronic device 101 may further include elements equivalent to the above-described elements. Further, in the electronic device of the present disclosure, specific structural elements may be excluded from the above-mentioned configuration or substituted with other structural elements according to their type. This may be easily understood by those skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a communication module that includes:
a first sub-communication module configured to perform a short-range wireless communication function,
a second sub-communication module configured to perform a wireless charging function, and
a third sub-communication module configured to perform a security payment function;
a coil module that includes:
a first coil used for performing the short-range wireless communication function, and
a second coil used for performing the wireless charging function;
a switch module that includes one or more switches that electrically connect the communication module with the coil module based on a control signal for controlling a connection between the communication module and the coil module; and
a processor configured to control to:
identify whether or not a signal for requesting activation of the third sub-communication module is received,
in response to the request signal being received, electrically connect the third sub-communication module, the first coil, and the second coil through the switch module, and
perform the security payment function by using the first coil and the second coil, which are connected with the third sub-communication module.

2. The electronic device of claim 1, wherein the first sub-communication module includes at least one of a near field communication (NFC) module or a Wi-Fi module,
wherein the second sub-communication module includes at least one of a wireless power consortium (WPC) module or a power matters alliance (PMA) module, and
wherein the third sub-communication module includes a magnetic secure transmission (MST) module.

3. The electronic device of claim 1, wherein the processor is further configured to control to:
transmit a channel connection request signal for making a communication channel with the external device to the external device through the first sub-communication module;
determine whether or not a channel connection response signal is received from the external device in response to the channel connection request signal;
request activation of the first sub-communication module when the channel connection response signal is received; and
request the activation of the third sub-communication module when the channel connection response signal is not received.

4. The electronic device of claim 1, wherein the processor is further configured to control the switch module such that the direction of the magnetic field generated in the first coil is the same as the direction of the magnetic field generated in the second coil in order to thereby electrically connect the third sub-communication module, the first coil, and the second coil.

5. The electronic device of claim 4, wherein the processor is further configured to control the switch module in order to thereby connect:
an output terminal of the third sub-communication module to an input terminal of the first coil;
an output terminal of the first coil to an input terminal of the second coil; and
an output terminal of the second coil to an input terminal of the third sub-communication module.

6. The electronic device of claim 1, wherein the processor is further configured to control to:
determine a proximity between the electronic device and the external device; and
connect one or more variable terminals, which are included in the first coil or the second coil, to the switch module based on the proximity.

7. The electronic device of claim 1, wherein the processor is further configured to control to connect one or more variable terminals, which are included in the first coil or the second coil, to the switch module based on the position state of the electronic device with respect to the external device.

8. The electronic device of claim 1, wherein the first coil and the second coil are arranged in a subordinate structure or in a parallel structure.

9. The electronic device of claim 8, wherein in the case where the first coil and the second coil are arranged in the parallel structure, if the distance between the first coil and the second coil is within a predetermined distance, the processor is further configured to control the connection of the third sub-communication module, the first coil, and the second coil such that the direction of the magnetic field generated in the first coil is opposite to the direction of the magnetic field generated in the second coil by using the switch module.

10. The electronic device of claim 1, wherein the processor is further configured to control to:
receive an input to execute a payment application;
create payment information for making a request to the external device for payment in response to the input; and
transmit the payment information to the external device through the first coil and the second coil connected with the third sub-communication module.

11. A method for performing wireless communication in an electronic device that includes a communication module that includes a first sub-communication module configured to perform a short-range wireless communication function, a second sub-communication module configured to perform a wireless charging function, and a third sub-communication module configured to perform a security payment function, the method comprising:
identifying whether or not a signal for requesting activation of the third sub-communication module is received;
in response to the request signal being received, electrically connecting the third sub-communication module, the first coil, and the second coil through a switch module; and
performing the security payment function by using the first coil and the second coil, which are connected with the third sub-communication module.

12. The method of claim 11, wherein the first sub-communication module includes at least one of a near field communication (NFC) module or a Wi-Fi module,
wherein the second sub-communication module includes at least one of a wireless power consortium (WPC) module or a power matters alliance (PMA) module, and
wherein the third sub-communication module includes a magnetic secure transmission (MST) module.

13. The method of claim 11, wherein the identifying comprises:
transmitting a channel connection request signal for making a communication channel with the external device to the external device through the first sub-communication module;
determining whether or not a channel connection response signal is received from the external device in response to the channel connection request signal;
requesting activation of the first sub-communication module when the channel connection response signal is received; and
requesting the activation of the third sub-communication module when the channel connection response signal is not received.

14. The method of claim 11, wherein the connecting comprises controlling the switch module such that the direction of the magnetic field generated in the first coil is the same as the direction of the magnetic field generated in the second coil in order to thereby electrically connect the third sub-communication module, the first coil, and the second coil.

15. The method of claim 14, wherein the connecting comprises controlling the switch module in order to thereby connect:
an output terminal of the third sub-communication module to an input terminal of the first coil;
an output terminal of the first coil to an input terminal of the second coil; and
an output terminal of the second coil to an input terminal of the third sub-communication module.

16. The method of claim 11, wherein the connecting comprises:
determining a proximity between the electronic device and the external device; and
connecting one or more variable terminals, which are included in the first coil or the second coil, to the switch module based on the proximity.

17. The method of claim 11, wherein the connecting comprises connecting one or more variable terminals, which are included in the first coil or the second coil, to the switch module based on the position state of the electronic device with respect to the external device.

18. The method of claim 11, wherein, in the operation of connecting, the first coil and the second coil are arranged in a subordinate structure or in a parallel structure.

19. The method of claim 18, further comprising, in the case where the first coil and the second coil are arranged in the parallel structure, if the distance between the first coil and the second coil is within a predetermined distance, controlling the connection of the third sub-communication module, the first coil, and the second coil such that the direction of the magnetic field generated in the first coil is opposite to the direction of the magnetic field generated in the second coil by using the switch module.

20. The method of claim 11, further comprising receiving an input to execute a payment application, wherein the execution comprises creating payment information for making a request to the external device for payment in response to the input, and transmitting the payment information to the external device through the first coil and the second coil connected with the third sub-communication module.
